(19) United States
(12) Patent Application Publication
(10) Pub. No.: US 2010/0182884 A1
(43) Pub. Date: Jul. 22, 2010

(54) Detecting mechanism of disc pick-and-place device

(76) Inventor: Hung-Jui Lin, Taipei City (TW)

Correspondence Address: G. LINK CO., LTD, 3550 BELL ROAD, MINOOKA, IL, 60447, US

(21) Appl. No.: 12/007,147

(22) Filed: Jan. 7, 2008

(51) Int. Cl. G11B 20/18

(52) U.S. Cl. 369/53.2; G9B/20.046

(57) ABSTRACT

A detecting mechanism of a disc pick-and-place device comprises a first frame and a pick-and-place head, a detecting portion and a sensor respectively coupled thereto. When the pick-and-place picks up at least two stacked discs, the detecting portion then shows a state different from when the pick-and-place head picks up one disc, and when the sensor senses that the detecting portion shows the different state, it may then output a corresponding signal thereby allowing the disc pick-and-place device to detect whether at least two discs are picked up and be prevented from placing at least two discs into a disc copier to avoid the incapability of copying and the speed decreasing of copying and even the damage of the copier.

### BACKGROUND OF THE INVENTION

1. Field of the Invention

The present invention relates to a disc pick-and-place device of an automatic disc copier, and more particularly to a detecting mechanism of the disc pick-and-place device.

2. Description of Related Art

The price of a disc is cheap and convenient for storing a great amount of data such that it is still an important data storing media. There are many automatic disc coping technologies, for example, an automatic disc burning method and apparatus disclosed in Taiwan Patent No. 594693, an automatic disc feeding and disc picking-up system for a disc burner disclosed in Taiwan Patent Publishing No. 200515395 and an automatic multiple discs backup apparatus for a personal computer disclosed in Taiwan Patent No. I228246. The Taiwan patents mentioned above all disclose a pick-and-place arm and a driving component used for driving the pick-and-place arm to rise and fall vertically and move transversely; the pick-and-place arm is used to automatically pick up a disc from or place a disc in a disc tray of a disc recording device or a disc tray of a disc cassette so as to attain to the automatic disc coping function.

A coping disc placed on the disc tray is usually stacked with another disc closely such that they are probably stuck together. If the disc pick-and-place head picks up at least two discs stuck together and places them in the disc tray of the copier, it will cause the disc tray to be unable to send the at least two stacked discs to a coping position or might damage the copier to cause the disc coping to be stopped when the at least two discs are abnormally copied even if they are sent to the coping position; this will influence the disc coping speed substantially.

### SUMMARY OF THE INVENTION

For allowing a disc pick-and-place device to have a function of detecting whether at least two stacked discs are picked up, the present invention is proposed.

The main object of the present invention is to provide a detecting mechanism of a disc pick-and-place device, allowing the disc pick-and-place device to concurrently have a function of detecting the number of discs picked up thereby.

Another object of the present invention is to provide a detecting mechanism of a disc pick-and-place device, capable of detecting whether at least two discs are picked up and preventing at least two discs from being placed in a disc copier to enable a copying thereof to be carried out smoothly, the coping speed not to be reduced and a copier not to be damaged.

For attaining to the objects mentioned above, the present invention proposes a detecting mechanism of a disc pick-and-place device, used for allowing the disc pick-and-place device to have a function of detecting whether at least two discs are picked up and comprising:

a first frame;

a pick-and-place head, coupled to the first frame and used for picking up or laying down a disc;

a detecting portion, coupled to the first frame and used for showing a different state corresponding to the difference in the number of discs picked up by the pick-and-place head; and

a sensor, coupled to the first frame and used for sensing a different state of the detecting portion to show a started or a not-started state;

wherein, when the pick-and-place head picks up at least two stacked discs, the detecting portion then shows a state different from when the pick-and-place head picks up one disc, and the sensor senses that the detecting portion shows the different state and then outputs a corresponding signal thereby allowing a disc pick-and-place device to have a function of detecting the number of discs picked up thereby concurrently, detect whether at least two discs are picked up and be prevented from placing at least two discs into a disc copier to avoid the incapability of copying and the speed decreasing of copying and even the damage of the copier.

### BRIEF DESCRIPTION OF THE DRAWINGS

The present invention can be more fully understood by reference to the following description and accompanying drawings, in which:

FIG. 1 is a side schematic view, showing a detecting mechanism of a disc pick-and-place device of a preferred embodiment according to the present invention;

FIG. 2 is a schematic view, showing a pick-and-place head of a detecting mechanism of a disc pick-and-place device of the preferred embodiment according to the present invention;

FIG. 3 is a schematic view, showing a detecting mechanism of a disc pick-and-place device of the preferred embodiment according to the present invention while picking up one disc; and

FIG. 4 is a schematic view, showing a detecting mechanism of a disc pick-and-place device of the preferred embodiment according to the present invention while picking up two stacked discs.

### DETAILED DESCRIPTION OF THE PREFERRED EMBODIMENTS

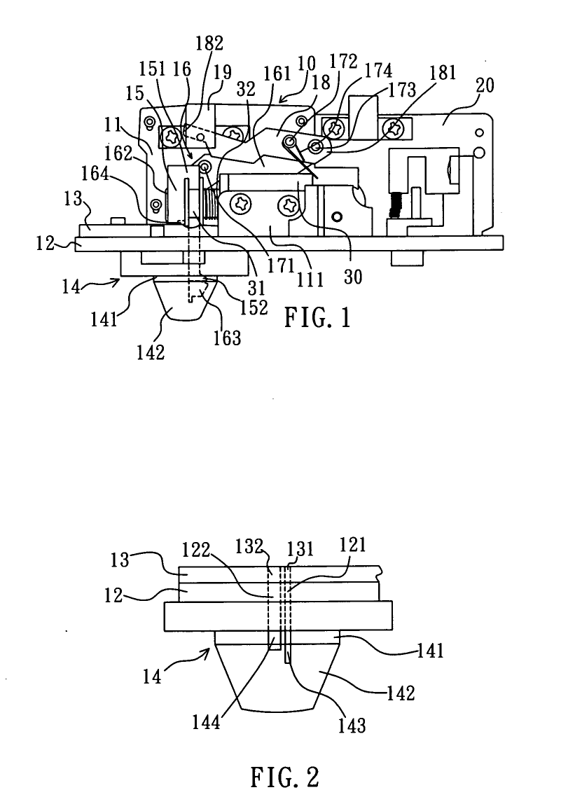

Please refer to FIGS. 1 and 2. According to a preferred embodiment of the present invention, a detecting mechanism of a disc pick-and-place device allows a pick-and-place head of the disc pick-and-place device to have a function of detecting whether at least two discs are picked up; it comprises a first frame 10 and a second frame 20 movably coupled to the first frame 10, in which the first frame 10 comprises a first vertical plate 11, a second vertical plate 111 and a level plate 12. Upper and lower sides of the level plate 12 are respectively coupled to a upper plate 13 and a pick-and-place head 14 as FIG. 2 shows. The pick-and-place head 14 is provided with a neck portion 141 and a cone-typed portion 142 connected to each other, a first slot 143 and a second slot 144, in which the first and the second slots 143 and 144 are respectively communicated with a upper end of the pick-and-place head 14 and the outside of flank sides of the neck portion 141 and the cone-typed portion 142. The level plate 12 and the upper plate 13 are respectively provided with third slots 121 and 131 as well as fourth slots 122 and 132 communicated with the first slot 143 and the second slot 144. A solenoid valve 30 is coupled to the second vertical plate 111 and placed between the first and the second vertical plates 11 and 111 and above the level plate 12, in which the solenoid valve 30 is disposed with a movable element 31 and a first elastic element 32. The first elastic element 32 always exerts a force moving the movable element 31 to leave the solenoid valve 30. When the solenoid valve 30 is acted, it can attract the movable element 31 to be near thereto. A upper end 151 of a clamping portion 15 is coupled to the movable element 31, and the clamping portion 15 may be driven by the movable element 31 to move levelly together with a lower end thereof is provided with a clamping element 152. The second slot 144 is used for accepting the clamping element 152. A detecting portion 16 comprises first and second sheets 161 and 162 bended with an angle (approximately 90 degrees) and a movable arm 18, in which a connection part of the first and the second sheets 161 and 162 is pivotally coupled to the first vertical plate 11 through a first shaft 171, a lower end of the second sheet 162 is provided with a detecting element 163 and the first detecting element 163 is accepted in the first slot 143. A blocking element 164 levelly extended is disposed on the second sheet 162. When the solenoid valve 30 is not acted, the blocking element 164 can be pressed by the movable element 31 to leave the solenoid valve 30 levelly. The movable arm 18 is pivotally coupled to the first vertical plate 11 through a second shaft 172 and provided with a first end 181 and a second end 182, in which the first end 181 thereof is pivotally coupled to one end of the first sheet 161 through a third shaft 173 and can be driven by the first sheet 161 to move up and down. A sensor 19, for example, optical interrupter or electro-mechanical switch is placed in the scope of operation of the second end 182 of the movable arm 18 such that it can be driven or not be driven depending on a position change of the second end 182. A second elastic element 174 is coupled to the first end 181 of the movable arm 18, always exerts a force moving the first end 181 upward and further to allow the detecting element 163 to maintain power moving it toward the outside of the first slot 143. The movable arm 18 may also not need to be used according to the present invention, the sensor 19 is directly allowed to position in the scope of operation of the second sheet 162 of the detecting portion 16; it may be started or not be started depending on a position change of the second sheet 162. Moreover, the second elastic element 174 may also be omitted according to the present invention, gravity force is used to exert on the detecting portion 16 to enable the detecting element 163 thereof to maintain power moving it toward the outside of the first slot 143.

According to the present invention, when a disc clamping apparatus does not pick up a disc, the solenoid valve 30 is not started, the first elastic element 32 presses the movable element 31 further to cause the clamping portion 15 and the detecting portion 16 to be positioned at a location far away from the solenoid valve 30; the first sheet 161 of the detecting portion 16 and the first end 181 of the movable arm 18 are positioned at a further lower location, and the second end 182 of the movable arm 18 is positioned at a further upper location to start the sensor 19. For example, the second end 182 of the movable arm 18 is positioned between a light emitting end and a light receiving end of a optical interrupter and in the meantime, the detecting element 163 and the clamping element 152 are accepted inside the first and the second slots 143 and 144 as FIGS. 1 and 2 show.

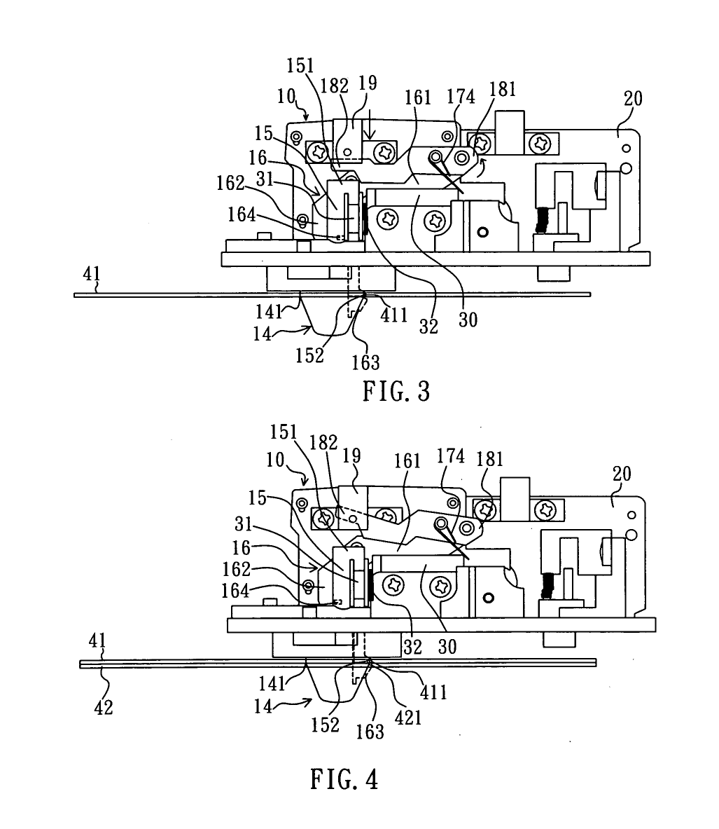

Please refer to FIGS. 2, 3 and 4. According to the present invention, when the disc pick-and-place device picks up a first disc 41, the solenoid valve 30 allows the movable element 31 to drive the clamping portion 15 to move to be near to the solenoid valve 30 to cause the clamping element 152 to be projected out of the second slot 144 to exert a force on a wall of a central circular hole 411 of the first disc 41 to enable the central circular hole 411 of the first disc 41 to be retained to and put around the neck portion 141 of the pick-and-place head 14 and in the meantime, the movable element 31 no more presses the blocking element 164, the first end 181 of the movable arm 18 is driven to move upward through the second elastic element 174 to cause the second end 182 to be moved downward and the detecting portion 16 to show a first state, for example, the second end 182 of the movable arm 18 is not positioned between a light emitting end and light receiving end of the optical interrupter, as FIG. 3 shows, the sensor 19 is not started so that the sensor 19 may output the first signal and in the meantime, the first end 181 is moved upward and drives an end of the first sheet 161 of the detecting portion 16 to move upward simultaneously to cause the detecting element 163 of the second sheet 162 to be projected outside the first slot 143. As FIG. 4 shows, when a lower side of the first disc 41 is stuck to a second disc 42, a wall of a central circular hole 421 of the second disc 42 limits a length of the detecting element 163 projected outside the first slot 143 so as to limit an amount of the first sheet 161 driven to move upward by the first end 181, i.e. the detecting portion 16 shows a second state, for example, the second end 182 of the movable arm 18 is positioned between the light emitting end and the light receiving end of the light interceptor such that the sensor 19 can output the second signal. A state that the sensor 19 emits the second signal when the solenoid valve 30 is open is detected through a microprocessor (not shown in the figure), it can then be known that the pick-and-place head 14 picks up the first and the second discs 41 and 42 stacked together. Thus, a follow-up step of placing the first and the second discs 41 and 42 back to a disc bin can then be carried out, and the second disc 42 is enabled to separate from the first disc 41 by allowing the second disc 42 to be dropped downward to touch the disc bin below or other discs, or the first and the second discs 41 and 42 stacked together are placed at an area for accepting unused discs thereby and not placed in a disc tray of a copier to avoid terminating the disc copying proceeding of the copier due to the incapability of placing the first and the second discs 41 and 42 into the disc tray of the copier or damaging the copier to terminate the disc copying proceeding of the copier; it can substantially prevent the copier form being damaged and/or the copying speed from being lowered.

The present invention allows a disc pick-and-place device to have a function of detecting the number discs picked up thereby concurrently, detect whether at least two discs are picked up and be prevented from placing at least two discs into a disc copier to avoid the incapability of copying and the speed decreasing of copying and even the damage of the copier. Besides, according to the present invention the design that a pick-and-place head is matched up with a clamping element to pick up and place in a disc may be replaced with a vacuum sucking disc mechanism.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended, claims and their equivalents.

What is claimed is:

1. A detecting mechanism of a disc pick-and-place device, used for allowing said disc pick-and-place device to have a function of detecting whether at least two discs are picked up and comprising:
a first frame;
a pick-and-place head, coupled to said first frame and used for picking up or laying down a disc;
a detecting portion, coupled to said first frame and used for showing a different state corresponding to the difference in the number of discs picked up by said pick-and-place head; and
a sensor, coupled to said first frame and used for sensing a different state of the detecting portion to show a started state or a not-started state;
wherein, when said pick-and-place head picks up at least two stacked discs, said detecting portion then shows a state different from when said pick-and-place head picks up one disc, and said sensor senses that said detecting portion shows said different state and then outputs a corresponding signal.

2. The detecting mechanism of a disc pick-and-place device according to claim 1, wherein said detecting portion comprises first and second sheets bended with an angle; said first frame comprises a first vertical plate and a level plate; a connection part of the first and the second sheets is pivotally coupled to said first vertical plate through a first shaft and a lower end of said second sheet is provided with a detecting element; said pick-and-place head and said level plate are respectively provided with a first slot and a third slot for allowing said detecting element to be passed through; in which when said pick-and-place head picks up a first disc, said detecting element is projected out of said first slot, said detecting portion then shows a first state; when said pick-and-place head picks up said first disc and a second disc, said detecting element is limited by a central circular hole of said second disc to reduce an amount thereof projected out of said first slot, said detecting portion then shows a second state.

3. The detecting mechanism of a disc pick-and-place device according to claim 2, wherein said detecting portion further comprises a movable arm; said movable arm is pivotally coupled to said first vertical plate through a second shaft; said movable arm is provided with a first end and a second end; said first end of said movable arm is pivotally coupled to an end of said first sheet through a third shaft; said sensor is placed in the scope of operation of said second end of said movable arm; in which said sensor is started or not started depending on a position change of said second end of said movable arm.

4. The detecting mechanism of a disc pick-and-place device according to claim 3, wherein said sensor is a optical interrupter or electro-mechanical switch.

5. The detecting mechanism of a disc pick-and-place device according to claim 4, wherein said first frame is coupled to a solenoid valve; one end of said solenoid valve is disposed with a movable element and a first elastic element; said first elastic element always exerts a force to move said movable element to leave said solenoid valve; in which, when said solenoid valve is acted, said movable element is attracted to move to be near to said solenoid valve; said second sheet is disposed with a blocking element; when said solenoid valve is not acted, said blocking element is then pressed by said movable element to leave said solenoid valve.

6. The detecting mechanism of a disc pick-and-place device according to claim 5, further comprising a second elastic element, said second elastic element always exerting a force on said detection portion to enable said detecting element to maintain power for extending said detecting element out of said first slot.

7. The detecting mechanism of a disc pick-and-place device according to claim 6, wherein said first end of said movable arm is coupled to said second elastic element; said second elastic element always exerts a force moving said first end of said movable arm to move upward and further to allow said detecting element to maintain power extending said detecting element out of said first slot.
